(19) United States
(12) Patent Application Publication
(10) Pub. No.: US 2022/0035796 A1
(43) Pub. Date: Feb. 3, 2022

(54) Block Confirmation Method, Device and Storage Medium

(71) Applicant: JIANGSU FUZAMEI TECHNOLOGY CO., LTD., Suzhou (CN)

(72) Inventors: Sijin WU, Suzhou (CN); Zhiwen WANG, Suzhou (CN)

(21) Appl. No.: 17/296,981

(22) PCT Filed: Nov. 23, 2019
(86) PCT No.: PCT/CN2019/120454

§ 371 Date: May 26, 2021

(30) Foreign Application Priority Data
Nov. 28, 2018 (CN) 201811430883.4

(51) Int. Cl. G06F 16/23; G06Q 20/38; H04L 9/32

(52) U.S. Cl. CPC G06F 16/2379; G06Q 20/389; H04L 2209/463; H04L 2209/38; H04L 9/3239

(57) ABSTRACT

A block confirmation method, a device, and a storage medium are provided. The method comprises: receiving several pieces of voting information of a first block, the voting information being generated by means of a signature after a committee node has received the first block packaged and broadcasted by a first recording node and verifies the first block successfully (S13); determining whether the voting information satisfies a preconfigured voting confirmation rule; if so, performing packaging according to the voting information to generate a first transaction (S14); and packaging the first transaction into a second block (S15). Said method shortens the block confirmation time, reduces the risk of double spending, improves the performance of blockchain systems, and provides a good user experience for users.

### BACKGROUND OF THE PRESENT INVENTION

### Field of Invention

The present invention relates to the technical field of blockchain, and more particularly to a block confirmation method, device, and storage medium.

### Description of Related Arts

According to conventional blockchain technology, a better consensus method comprises the following steps: selecting a plurality of fixed super-nodes with stronger public credibility to form a consensus committee, wherein the consensus committee node alternately packs the transaction to generate blocks, and votes to generate block vote to confirm blocks through a BFT two-stage voting manner; and the method enables the generated blocks to have strong synchronicity and does not diverge. Strong synchronicity refers to that the non-modifiable height of the block is the same as the actual height of the block, i.e., the packed transaction generates a block, and the next round of consensus will begin after the block is confirmed. While strong synchronicity is able to, on the one hand, ensure that the blockchain does not produce a double spending problem, on the other hand, render the problem that the block confirmation consumes a longer time.

### SUMMARY OF THE PRESENT INVENTION

In view of the above-mentioned drawbacks or deficiencies in the prior art, it would be desirable to provide a block confirmation method, device, and storage medium that can shorten the block confirmation time and reduce the risk of double spending problem.

In a first aspect, the present invention provides a block confirmation method, including:

receiving several pieces of voting information of a first block, wherein the voting information is generated by means of a signature after a committee node has received the first block packaged and broadcasted by a first recording node and verifies the first block successfully;

determining whether the voting information satisfies a preconfigured voting confirmation rule; if so, performing packaging according to the voting information to generate a first transaction; and

packaging the first transaction into a second block.

In a second aspect, the present invention also provides a device, comprising one or more processors and memories, wherein the memory comprises commands executable by the one or more processors to enable the one or more processors to perform a block confirmation method provided in accordance with the embodiments of the present invention.

In a third aspect, the present invention also provides a storage medium storing a computer program that enables a computer to perform a block confirmation method provided in accordance with the embodiments of the present invention.

Various embodiments of the present invention provide a block confirmation method, device, and storage medium, through receiving several pieces of voting information of a first block, wherein the voting information is generated by means of a signature after a committee node has received the first block packaged and broadcasted by a first recording node and verifies the first block successfully; determining whether the voting information satisfies a preconfigured voting confirmation rule; if so, performing packaging according to the voting information to generate a first transaction; and packaging the first transaction into a second block. The method shortens the block confirmation time, reduces the risk of double spending, improves the performance of blockchain systems, and provides a good user experience for users.

The block confirmation method, device and storage medium provided by some embodiments of the present invention further optimize the user experience and reduce the risk of double spending through configuring the second block as the next block of the first block, so as to achieve an synchronization block confirmation method with the non-modifiable height of the block same as the actual height of the block that the voting operation is synchronized with the block confirmation.

The block confirmation method, device, and storage medium provided by some embodiments of the present invention further optimize the user experience, improve the performance of the blockchain system, and shorten the block confirmation time through configuring the second block as the nth block after the first block, wherein n is a positive integer greater than 1, so as to achieve an asynchronous block confirmation method with the non-modifiable height of the block different from the actual height of the block that the voting operation is asynchronous with the block confirmation operation.

The block confirmation method, device, and storage medium provided by some embodiments of the present invention further optimize the user experience through judging whether the quantity of voting information currently received is not less than the quantity of voting information required by the current time point confirmation block for confirming the block: if yes, selecting voting information which does not exceed the quantity of votes allowed by the current time point from the voting information, and packing the selected voting information to generate a first transaction, so that the blockchain system can continue to operate even if only a small number of nodes operate normally.

The block confirmation method, device, and storage medium provided by some embodiments of the present invention further optimize the user experience, enhance the performance of the blockchain systems, and reduce the risk of blockchain system jam through monitoring whether other voting information is accepted from the time when the first transaction is packed into the second block, wherein if yes, certain credit held by the nodes that sent other voting information will be taken off, so that the committee node of the first block does not continuously broadcast the voting information of the first block.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a flow diagram of a block confirmation method according to one embodiment of the present invention.

FIG. 2 is an application view of the step S14 of the block confirmation method according to the embodiment of FIG. 1.

FIG. 3 is a flow diagram of a preferred embodiment of the method of FIG. 1.

FIG. 4 is a structural schematic diagram of a device according to one embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

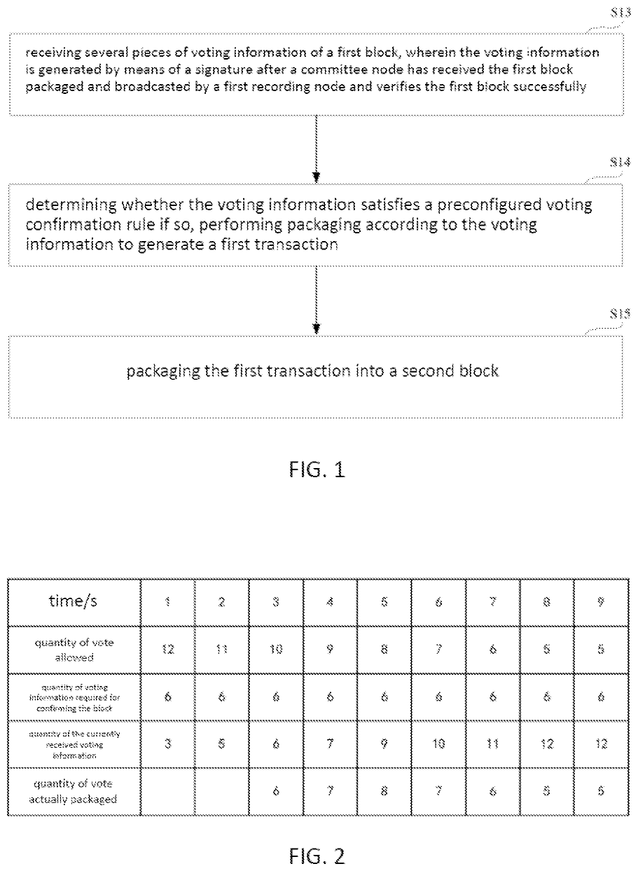

FIG. 1 is a flow diagram of a block confirmation method according to an embodiment of the present invention. Referring to FIG. 1, according to the present embodiment, the present invention provides a block confirmation method, comprising:

S13: receiving several pieces of voting information of a first block, wherein the voting information is generated by means of a signature after a committee node has received the first block packaged and broadcasted by a first recording node and verifies the first block successfully;

S14: determining whether the voting information satisfies a preconfigured voting confirmation rule; if so, performing packaging according to the voting information to generate a first transaction; and

S15: packaging the first transaction into a second block.

Specifically, the quantity of the committee nodes participating in the voting of each round preconfigured in the blockchain network is 12; the recording node of the first block is the recording node A, and the recording node of the second block is the recording node B; the pre-configured voting confirmation rule is: judging whether the quantity of voting information currently received is not less than the quantity of voting information required by the current time point confirmation block for confirming the block; and the quantity of the voting information currently received is 8 votes, and the quantity of voting information required by the current time point confirmation block for confirming the block is 6 votes.

In the step S13, the recording node B receives several pieces of voting information of a first block, wherein the voting information is generated by means of a signature after a committee node has received the first block packaged and broadcasted by the recording node A and verifies the first block successfully.

In the step S14, because the quantity of the voting information currently received is 8 votes and the quantity of the voting information required by the current time point confirmation block for confirming the block is 6 votes, the recording node B will determine that the quantity of the voting information currently received is not less than the quantity of the voting information required by the current time point confirmation block for confirming the block and pack and generate the voting information of the 8 votes into a first transaction.

In the step S15, the recording node B packages the first transaction into a second block.

According to the above embodiment, a block confirmation method provided by the present invention is illustrated in detail for the example that the quantity of the committee nodes participating in the voting of each round preconfigured in the blockchain network is 12; the recording node of the first block is the recording node A, and the recording node of the second block is the recording node B; the pre-configured voting confirmation rule is: judging whether the quantity of voting information currently received is not less than the quantity of voting information required by the current time point confirmation block for confirming the block; the quantity of the voting information currently received is 8 votes, and the quantity of voting information required by the current time point confirmation block for confirming the block is 6 votes. In some other embodiments, it may configure the quantity of the committee node as any other positive integer based on the needs and configure the voting confirmation rule or so to judge if the quantity of the voting information currently received not less than the quantity of voting information required by the current time point confirmation block and still achieve the same technical result.

The above embodiment shortens the block confirmation time, reduces the risk of double spending, improves the performance of blockchain systems, and provides a good user experience for users.

According to a preferred embodiment, the second block is the next block of the first block. Specifically and exemplarily, the first block is a block with a block height of H−1, the second block is a block with a block height of H, the recording node of the first block is an recording node A, and the recording node of the second block is an recording node B.

In the step S13, the recording node B receives several pieces of voting information of block with block height equals to H−1, wherein the voting information is generated by means of a signature after a committee node has received the block with block height equals to H−1 packaged and broadcasted by the recording node A and verifies the block with block height equals to H−1 successfully.

In the step S14, because the quantity of the voting information currently received is 8 votes and the quantity of the voting information required by the current time point confirmation block for confirming the block is 6 votes, the recording node B will determine that the quantity of the voting information currently received is not less than the quantity of the voting information required by the current time point confirmation block for confirming the block and pack and generate the voting information of the 8 votes into a first transaction.

In the step S15, the recording node B packages the first transaction into a block with block height equals to H.

The above embodiment further optimizes the user experience and reduce the risk of double spending through configuring the second block as the next block of the first block, so as to achieve a synchronization block confirmation method with the non-modifiable height of the block same as the actual height of the block that the voting operation is synchronized with the block confirmation.

According to a preferred embodiment, the second block is the nth block after the first block, and n is a positive integer greater than 1. Specifically and exemplarily, the first block is a block with a block height of H−1, the second block is a block with a block height of H+1, the recording node of the first block is an recording node A, and the recording node of the second block is an recording node C.

In the step S13, the recording node C receives several pieces of voting information of block with block height equals to H−1, wherein the voting information is generated by means of a signature after a committee node has received the block with block height equals to H−1 packaged and broadcasted by the recording node A and verifies the block with block height equals to H−1 successfully.

In the step S14, because the quantity of the voting information currently received is 8 votes and the quantity of the voting information required by the current time point confirmation block for confirming the block is 6 votes, the recording node C will determine that the quantity of the voting information currently received is not less than the quantity of the voting information required by the current time point confirmation block for confirming the block and pack and generate the voting information of the 8 votes into a first transaction.

In the step S15, the recording node C packages the first transaction into a block with block height equals to H.

According to the above embodiment, the block confirmation method is described in detail through an example of n=2, and according to other embodiments, n may be configured as other positive integer greater than 1 based on actual requirements, which may also achieve the same technical results.

The above embodiment further optimize the user experience, improve the performance of the blockchain system, and shorten the block confirmation time through configuring the second block as the nth block after the first block, wherein n is a positive integer greater than 1, so as to achieve an asynchronous block confirmation method with the non-modifiable height of the block different from the actual height of the block that the voting operation is asynchronous with the block confirmation operation.

In a preferred embodiment, determining whether each vote satisfies a pre-configured voting confirmation rule, which comprises: determining whether the quantity of voting information currently received is not less than the quantity of voting information required by the current time point confirmation block for confirming the block, wherein the quantity of voting information required by the current time point confirmation block for confirming the block is determined according to a relationship between the pre-configured block packing timer and the quantity of voting information required to confirm the block.

Specifically and exemplarily, the quantity of the currently received voting information is 8 votes and the quantity of voting information required by the current time point confirmation block for confirming the block is 6 votes. Because the quantity of the voting information currently received is 8 votes and the quantity of the voting information required by the current time point confirmation block for confirming the block is 6 votes, the recording node B will determine that the quantity of the voting information currently received is not less than the quantity of the voting information required by the current time point confirmation block for confirming the block and pack and generate the voting information of the 8 votes into a first transaction.

FIG. 2 is an application view of the step S14 of the block confirmation method according to the embodiment of FIG. 1. As illustrated in FIG. 2, according to a preferred embodiment, the step S14 further comprises:

S142: determining whether the quantity of the currently received voting information is not less than the quantity of voting information required by the current time point confirmation block:

if yes, the voting information which does not exceed the quantity of votes allowed by the current time point is selected from the voting information, and the selected voting information is packaged to generate the first transaction.

Specifically, for the example that the current time is 8 s, the quantity of currently received voting information is 12 votes, the quantity of voting information required by the current time point confirmation block for confirming the block is 6 votes, and the quantity of submitted votes allowed at the current time point is 5 votes.

In the step S142, because the quantity of the voting information currently received is 12 votes, the quantity of the voting information required by the current time point confirmation block for confirming the block is 6 votes, and the quantity of submitted votes allowed at the current time point is 5 votes; the recording node will determine that the quantity of the voting information currently received is not less than the quantity of the voting information required by the current time point confirmation block for confirming the block, select 5 votes from the 12 votes currently received, and pack them to generate a first transaction.

In more embodiments, the same technical effect may be achieved according to the actual demands through modifying the quantity of votes allowed by the current time point.

The above embodiment allows the blockchain system to continue to operate even if only a small quantity of nodes are normally operating. If the quantity of votes allowed to submit at the current time point is configured as 1 vote, the blockchain system can continue to run even if only one node is operating normally, which further optimizes the user experience.

According to a preferred embodiment, the first transaction is packaged into a second block, which comprises:

sorting and packaging the first transaction with other common transactions to a second block, wherein the arrangement sequence number of the first transaction is the first.

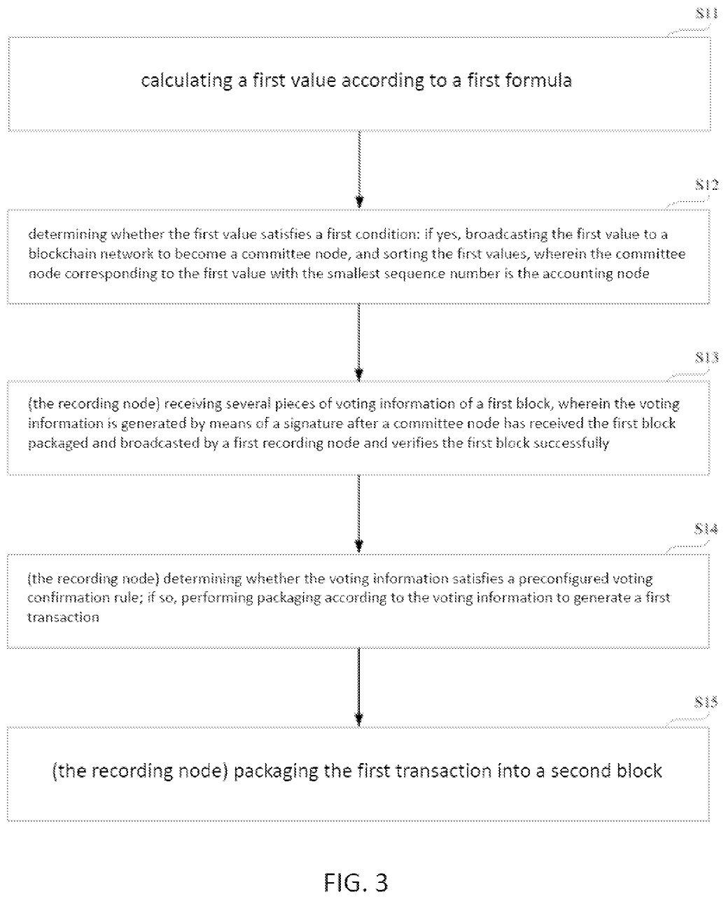

FIG. 3 is a flow diagram of a preferred embodiment of the method of FIG. 1. Referring to FIG. 3, according to a preferred embodiment, before receiving several pieces of the voting information of the first block, the node of the blockchain further performs the following operations:

S11: calculating a first value according to a first formula; and

S12: determining whether the first value satisfies a first condition:

if yes, broadcasting the first value to a blockchain network to become a committee node, and sorting the first values, wherein

the committee node corresponding to the first value with the smallest sequence number is the accounting node.

Specifically, for an example that it is determined whether the first value satisfies a first condition configured as whether the first value is less than the system difficulty value:

In the step S11, calculating a first value according to a first formula.

In the step S12, determining if the first value is less than the system difficulty value:

if yes, broadcasting the first value to a blockchain network to become a committee node, and sorting the first values, wherein

the committee node corresponding to the first value with the smallest sequence number is the accounting node.

According to some other embodiments, the same technical effect may also be achieved through the configurations that whether the first value satisfies the first condition that whether the first value is less than the block hash of the previous block, or the like, based on the actual needs.

The above embodiment provides a method for screening committee node. For the example that the first block is a block with a block height of H−1, the second block is a block with a block height of H, the recording node of the first block is an recording node A, and the recording node of the second block is an recording node B; when the block height is H−1, committee nodes with block height of H−1 are screened through the above method. Within these committee nodes with block height of H−1, the node with the smallest first numerical value is the node A, the node A is the recording node of the block with the block height H−1, and the node A is denoted as the recording node A. When the block height is H, committee nodes with block height of H are screened through the above method. Within these committee nodes with block height of H, the node with the smallest first numerical value is the node B, the node B is the recording node of the block with the block height of H, and the node B is denoted as the recording node B. The committee node and the recording node of each block are different, so that conspiracy between the committee node and the recording node is prevented.

According to a preferred embodiment, the configuration of the first formula is:

hash1=Hash(sig(Hash(addr( )+time+hash(H−1)+hash(H−2)+hash(H−3)))), where H is the block height of the second block, hash1 is the first value, Hash( ) is the hash algorithm, sig( ) is the encryption algorithm, addr( ) is the public key address of the node, time is the generation time of the first block, hash(H−1) is the first value of the recording node of the first block before the second block, hash(H−2) is the first value of the recording node of the second block before the second block, hash(H−3) is the first value of the recording node of the third block before the second block.

According to some other embodiments, the first formula may also be configured as hash1=Hash(sig(Hash(addr( )+time+X))), according to actual needs, wherein X is any available block information.

According to a preferred embodiment, the node of the blockchain is configured with a first contract, adapted for:

the system difficulty value is adjusted every predetermined block height, wherein whether the first value satisfies the first condition is determined according to the system difficulty value.

Specifically, the system difficulty value is adjusted between every 50 block height intervals; when the current block height is 100, in a block with a block height of 51 to a block with a block height of 100, there is generally a need to spend too much time to generate enough committee nodes; and whether the first value meets the first condition is determined according to the system difficulty value: determining whether the first value is less than the system difficulty value: if yes, the first numerical value is broadcast into the blockchain network to become the committee node.

Since, for a block with a block height of 51 to a block with a block height of 100, there is generally a need to spend too much time to generate enough committee nodes, and whether the first value satisfies the first condition is configured according to the system difficulty value: whether the first value is less than the system difficulty value: if yes, broadcasting the first value into the blockchain network to become a committee node; it is believed that in a block with a block height of 51 to a block with a block height of 100, the value of the system difficulty value is relatively small, such that there is a need to spend a longer time until there are enough nodes to satisfy a condition that the first value is less than the system difficulty value to generate a committee node; therefore, there is a need to increase the value of the system difficulty value.

According to a preferred embodiment, the node of the blockchain is configured with a first contract, adapted for: after the committee node receives the first block packaged and broadcasted by the first recording node and after the first block is successfully verified and signed, certain interests held by the committee node is deducted.

Specifically, a bifurcation is generated in a blockchain system, and for example, a chain M and a chain N are formed after the bifurcating, wherein the chain M is, for example, in the correct chain.

If the committee node votes for the correct M-chain in the voting, the voting information of the committee node will be packaged by the recording node of the next round of consensus to generate a second block, and after the second block is verified successfully, the voting reward will be obtained, wherein the value of the obtained voting reward is higher than the value of credits that was deducted.

If the committee node votes for the incorrect N-chain in the voting, the voting information of the committee node will be packaged by the recording node of the next round of consensus to generate a second block, and after the second block is verified successfully, the voting reward will not be obtained. Therefore, the committee node will lose some credit owned, which motivate the committee node to vote for the correct chain.

If the committee node votes for both the correct M-chain and the incorrect N-chain at the same time of voting, which constitutes a malicious vote, the voting information of the committee node will be packaged by the recording node of the next round of consensus to generate a second block, and after the second block is verified successfully, the voting reward will not be obtained, and some credits held by the committee node will be taken, wherein the value of the penalty is higher than the value of the obtained voting reward.

According to a preferred embodiment, the node of the blockchain is configured with a first contract, adapted for: monitoring if voting information of other first block from the time at which each of the voting information is packaged to generate the first transaction is received: if yes, deducting a certain right held by the node broadcasting the voting information of the other first block.

Specifically, it is for the example that the recording node of the second block is the recording node B, the quantity of the voting information currently received is 10 votes, the quantity of voting information required by the current time point confirmation block for confirming the block is 6 votes, the current time point is allowed to submit the voting quantity of 5 votes, the recording node B selects 5 votes from the voting information of the currently received 10 votes to pack and generate the first transaction, wherein afterward the voting information broadcasted by the committee node Y of the first block is still received; then, some credits held by the committee node Y will be deducted.

According to the above embodiment, a penalty measure is configured so that the committee node of the first block does not continuously broadcast the voting information of the first block, which reduces the congestion risk of the blockchain system, increases the performance of the blockchain system, and further optimizes the user experience.

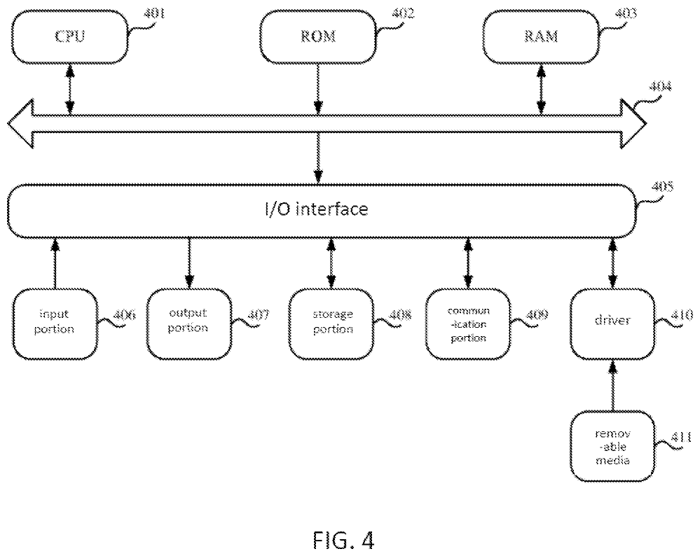

FIG. 4 is a composition diagram of a device according to an embodiment of the present invention.

Referring to FIG. 4, in another aspect, the present application also provides a device 400, which includes one or more central processing units (CPU) 401 that can perform various suitable actions and processes in accordance with a program stored in a read-only memory (ROM) 402 or a program loaded into a Random Access Memory (RAM) 403 from a storage portion 408. Various programs and data required for the operation of the device 400 are also stored in the RAM 403. The CPU 401, the ROM 402, and the RAM 403 are connected to each other via a bus 404. An input/output (I/O) interface 405 is also connected to the bus 404.

The following components are connected to the I/O interface 405: an input portion 406 including a keyboard, a mouse, and etc.; an output portion 407 including a cathode ray tube (CRT), a liquid crystal display (LCD), and etc., and a speaker and etc.; a storage portion 408 including a hard disk or the like; and a communication portion 409 including a network interface card, such as a LAN card, a modem, and etc. The communication portion 409 performs communication process via a network, such as the Internet. A driver 410 is also connected to the I/O interface 405 based on the needs. A removable media 411, such as magnetic disks, optical disks, magneto-optical disks, semiconductor memories, and etc., is mounted on the driver 410 based on the needs so that the computer programs read therefrom can be installed into the storage portion 408 as needed.

In particular, according to the embodiments of the present invention, the block confirmation methods described in any of the above embodiments may be implemented as the computer program. For example, an embodiment of the present invention may provide a computer program product, which includes a computer program tangibly loaded on a machine-readable medium containing program code for performing a block confirmation method. According to such embodiment, the computer program may be downloaded and installed from the network through the communication portion 409 and/or installed from the removable medium 411.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform a block confirmation method disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself.

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

What is claimed is:

1. A block confirmation method, comprising:
receiving several pieces of voting information of a first block, wherein the voting information is generated by means of a signature after a committee node has received the first block packaged and broadcasted by a first recording node and verifies the first block successfully;
determining whether the voting information satisfies a preconfigured voting confirmation rule; if so, performing packaging according to the voting information to generate a first transaction; and
packaging the first transaction into a second block.

2. The method, as recited in claim 1, wherein the second block is a next block of the first block.

3. The method, as recited in claim 1, wherein the second block is the nth block after the first block, and n is a positive integer greater than 1.

4. The method, as recited in any of claims 1-3, wherein the step to determine whether each of the voting information satisfies the preconfigured voting confirmation rule comprises:
determining whether the quantity of the currently received voting information is not less than the quantity of voting information required by the current time point confirmation block for confirming the block, wherein the number of voting information required by the current time point confirmation block for confirming the block is determined according to the relationship between the preconfigured block packing timer and the quantity of voting information required for confirming the block.

5. The method, as recited in any of claims 1-3, wherein for said step to determine whether each of the voting information satisfies the preconfigured voting confirmation rule: if yes, packaging to generate a first transaction according to the voting information, which comprises:
determining whether the quantity of the currently received voting information is not less than the quantity of voting information required by the current time point confirmation block for confirming the block:
if yes, the voting information which does not exceed the quantity of votes allowed by the current time point is selected from the voting information, and the selected voting information is packaged to generate the first transaction.

6. The method, as recited in any of claims 1-3, wherein the step of packing the first transaction into the second block comprises:
sorting and packaging the first transaction with other common transactions to a second block, wherein the arrangement sequence number of the first transaction is the first.

7. The method, as recited in any of claims 1-3, wherein before receiving several pieces of the voting information of the first block, the node of the blockchain further performs the following operations:
calculating a first value according to a first formula; and
determining whether the first value satisfies a first condition:
if yes, broadcasting the first value to a blockchain network to become a committee node, and sorting the first values, wherein the committee node corresponding to the first value with the smallest sequence number is the accounting node.

8. The method, as recited in claim 7, wherein the first formula is configured as:
hash1=Hash(sig(Hash(addr( )+time+hash(H−1)+hash(H−2)+hash(H−3)))), where H is the block height of the second block, hash1 is the first value, Hash( ) is the hash algorithm, sig( ) is the encryption algorithm, addr( ) is the public key address of the node, time is the generation time of the first block, hash(H−1) is the first value of the recording node of the first block before the second block, hash(H−2) is the first value of the recording node of the second block before the second block, hash(H−3) is the first value of the recording node of the third block before the second block.

9. The method, as recited in claim 7, wherein the node of the blockchain is configured with a first contract, adapted for:
the system difficulty value is adjusted every a predetermined block height, wherein whether the first value satisfies a first condition is determined according to the system difficulty value.

10. The method, as recited in any of claims 1-3, wherein the node of the blockchain is configured with a first contract, adapted for:
after the committee node receives the first block packaged and broadcasted by the first recording node and after the first block is successfully verified and signed, certain interests held by the committee node is deducted.

11. The method, as recited in any of claims 1-3, wherein the node of the blockchain is configured with a first contract, adapted for:
monitoring if voting information of other first block from the time at which each of the voting information is packaged to generate the first transaction is received:
if yes, deducting a certain right held by the node broadcasting the voting information of the other first block.

12. A device, comprising:
one or more processors; and
a storage, adapted for storing one or more program, wherein when said one or more program was executed by said one or more processor, said one or more processor is allowed to execute the method, as recited in any of the claims 1-11.

13. A storage medium with program stored therein, wherein said program is executed by a processor so as to perform the method, as recited in any of the claims 1-11.
